(19) United States
(12) Patent Application Publication
(10) Pub. No.: US 2005/0062309 A1
(43) Pub. Date: Mar. 24, 2005

(54) Tailgate module

(76) Inventors: Robert Juzwiak, Plymouth, MI (US); Aaron Berendt, Milford, MI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/801,104

(22) Filed: Mar. 15, 2004

Related U.S. Application Data
(63) Continuation of application No. PCT/US02/29187, filed on Sep. 13, 2002.
(60) Provisional application No. 60/318,955, filed on Sep. 13, 2001.

(51) Int. Cl. B62D 33/023

(52) U.S. Cl. 296/51

(57) ABSTRACT

A tailgate module for a vehicle is disclosed. The tailgate module includes features of a working surface including grooves or recesses to restrict movement of a tool in the x, y and z directions. The tailgate module comprises a top work surface (21) comprising one or a plurality of slots (13) configured to locate a base of a tool (14) in a first direction and a second direction. The second direction is preferably substantially perpendicular to the first direction. The slots cooperate with a downwardly extending protrusion on the base of said tool. A clamp (24) restricts movement of the base in a direction perpendicular to the first and said second directions.

### CROSS REFERENCE TO RELATED APPLICATIONS

This application is a continuation of International Application No. PCT/US02/29187 filed Sep. 13, 2002 and published Mar. 20, 2003 as International Publication No. WO 03/022634, designating the United States, and which claims benefit of U.S. Provisional Application No. 60/318,955 filed Sep. 13, 2001.

### FIELD OF INVENTION

The present invention relates to a tailgate module for a vehicle having the features of a field working surface, more specifically, grooves or recesses molded into the surface that could mount or support various tools and could position construction materials.

### BACKGROUND OF THE INVENTION

There are a number of “handyman” inventions which are adaptable to small truck bodies and tailgates and which can fixture or hold construction materials.

For instance, U.S. Pat. No. 5,169,202 “Multiple-Use Workbench for Use as a Tailgate on a Truck” to Cupp, et al. discloses an improved fold down tailgate which employs a slotted work surface that permits the ready attachment of various construction implements, such as cargo ramps, extended work surfaces, and a variety of vises, clamps and tie-down devices. Claim 1 refers to “multiple strips of material aligned generally perpendicular to the work surface; gaps provided between strips of materials” and “wherein various implements may be attached to the work surface by passing attachment means through one of said gaps”. While this metal grating is versatile for attaching items, it suffers aesthetically and is difficult to use as a traditional tailgate that one would slide items across.

U.S. Pat. No. 5,556,151 “Tailgate Ruler and Fixturing Device” to New, et al. discloses “a fixturing device/scale combination that is permanently located where it is likely to be used and which is attached to the pickup or trailer . . . in order to facilitate measuring lengths and angles for cutting lumber and other materials”. Column 3, lines 12-15, recite that “the present invention eliminates the need for clamps or other fastening devices by providing single or multi-stepped channels into which standard width lumber may be restrained during sawing or marking”. Column 3, lines 26-32 recite “The present invention further contemplates use of a protractor attachment permanently or releasably affixed to the restraint channel with the purpose of providing a convenient means of making angled cuts on the material so affixed. In addition, miter slots may also be provided at set angular relationships with respects to the axis of the material restraint channel”. However, this reference does not deal with means to hold manual or power tools.

U.S. Pat. No. 5,136,953 “Tail gate Table” to Schmidt discloses a tailgate table for mounting on the rear upstanding wall of an automobile truck enclosure.

U.S. Pat. No. 5,267,748 “Vehicle Tool Platform Apparatus and Method” to Curran discloses a vehicle tool platform apparatus adapted for use with and attachment to a work type truck having a rear tailgate, said truck having a rear hitch. The apparatus is attached to the hitch and is cantilevered out to be flush with the rear edge of the tailgate.

U.S. Pat. No. 3,844,158, “Mobile Muffler Shop” to Mercer discloses a tube bender mounted on the rear end and enclosed in a body that provides storage for mufflers and tail pipes.

U.S. Pat. No. 4,516,308 “Portable Workshop” to Urban discloses portable workshop having various facilities for performing precision machine work at a work site and which includes a mobile trailer and trailer hitch.

U.S. Pat. No. 4,576,395 “Trailer Hitch Mounted Tool Support” to Longoria discloses an upstanding support which telescopes over a hitch ball. The upper end of the upstanding support mounts a horizontal mounting plate therefrom which may be utilized to support a plurality of different objects such as a grinder, workbench, hoist, cycle carrier, sign, floodlight, pipe rack or the like.

U.S. Pat. No. 5,082,037 “tool Support Assembly” to Hammons, et al. discloses a similar device which is mounted to the bumper of a vehicle.

U.S. Pat. No. 5,518,158 “Pickup Truck Tail Gate Tool Box Assembly” to Matlack discloses a tailgate tool box assembly for a pickup truck which includes a tool box having an attachment member mounted on an inner side of the pickup tailgate and a tool storage compartment pivotally hinged to the attachment member (such that in the open position the tools are readily accessible).

U.S. Pat. No. 4,266,821 “Combined Tailgate and Tool Box” to Gillet discloses a modified tool box and modified tailgate combination, primarily for pickup, trucks, wherein the tool box is mounted to pivot from a storage-travel position on the floor of the pickup, to an open-access position with the tail gate open and extended.

U.S. Pat. No. 4,949,945 “Vise Swivel Mount” to whiteley discloses a vise swivel mount for use in vehicle which includes a swivel socket bolted directly to the bed of the vehicle, to support a vise.

U.S. Pat. No. 5,649,734 “Tail Gate Box, Table and Sink” to Speis discloses a fold-up combination tailgate table, sink and storage box for the rear of a pickup truck. In the unfolded position, the assembly is extremely stable and can support considerable weight. It becomes a table; a storage container; a sink for liquids, and with several optional circular holes, a holder for bottles, drinks or other containers.

While these aforementioned devices deal with work surfaces, tool boxes and attachments to other vehicle components (trailer hitch, bumper, etc.) none contemplate a tailgate inner liner, or full tailgate module, having channels or grooves in its surface into which tools can be positively located and locked. These fixtures may then be activated on the tailgate surface as a work platform to cut, form and modify a variety of construction materials.

### SUMMARY OF THE INVENTION

The present invention is directed at a molded tailgate inner surface having grooves or recesses capable of receiving and holding, e.g., power tools to service a variety of construction industries. The tailgate module is preferably molded of plastic either as an inner liner secured to a metal tailgate outer, or as a plastic tailgate of unitary construction into which locating grooves have been formed.

An additional feature of the tailgate module are locking mechanisms for the various tools to enhance safe operation.

Additionally, the tailgate module may be tailored for specific crafts with different groove spacings to accept tools of different base dimensions for a variety of different construction tools (a saw, a vise, or bender, for instance).

The module would preferably be molded of plastic and the surface configurable to various construction industries (carpentry, plumbing, heat and ventilation, sheet metal, roofing, etc.) where materials are cut or formed to length.

In another embodiment, the tailgate module surface includes stock guides which fold out of the way when not in use, stock straps to hold construction materials prior to measuring and cutting and a close-by source of electrical power.

Further, the invention is not limited to power tools but could include any sort of manual or powered device employed for changing the dimensions of industrial goods.

### BRIEF DESCRIPTION OF THE DRAWINGS

These and other objects, features and advantages of the invention will become apparent upon consideration of the description of the invention and the appended drawings in which:

FIG. 1 shows a perspective view of a pickup truck bed with the tailgate module of the invention in place ready for installation of a tool;

FIG. 2 is a partial view of FIG. 1 focusing on the area where a tool would be located showing some detail of the locking mechanism.

FIG. 3 is a sectional view of the circled area of FIG. 2 showing in further detail one means of locking a tool in place.

### DESCRIPTION OF THE PREFERRED EMBODIMENTS

For elements common to the various embodiments of the invention, the numerical reference character between the embodiments is held constant, but distinguished by the addition of an alphanumeric character to the existing numerical reference character. In other words, for example, an element reference at 10 in the first embodiment is correspondingly referenced at 10A, 10B and so forth in subsequent embodiments. Thus, where an embodiment description uses a reference character to refer to an element, the reference character applies equally, as distinguished by alphanumeric character, to the other embodiments where the element is common.

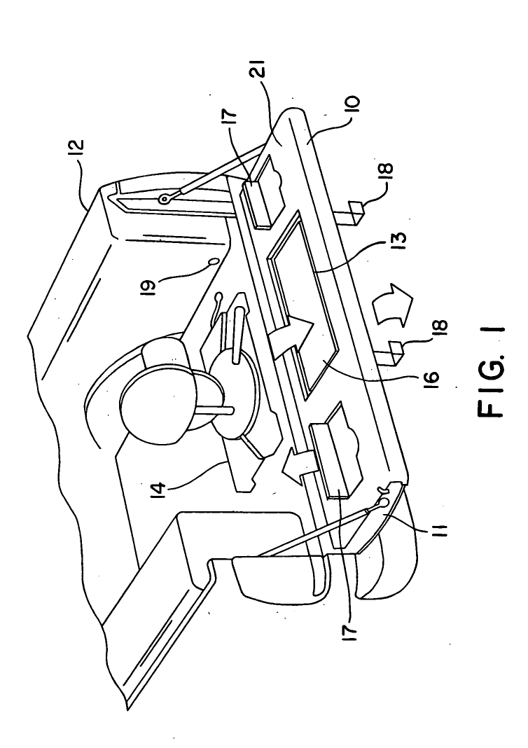

Referring now to the figures, FIG. 1 shows the molded tailgate module 10 as an inner liner attached to a conventional sheet metal tailgate outer 11, in an extended or working position on a pickup truck bed 12. A downwardly opening extending slot 13 surrounds a support surface 16. A feature in the slot is designed to coincide dimensionally with a downwardly protruding portion of a power tool 14, in this case a miter saw. The surrounding slot 13 is designed to positively locate and hold a power tool 14 in the x and y direction by receiving the marginal edges of the tool base. The surface 16 is preferably level with the surrounding surface 21. However, the support surface 16A and/or the slots may be designed so that the top surface of the power tool when installed, is level with the surrounding surface 21. Alternatively, the power tool may include a single protrusion or a plurality of protrusions that align with a cooperating depression or plurality of depressions in the tail gate module. The protrusion and cooperating depression positively locate a base of a power tool 14 in a first direction and a second direction, the second direction being perpendicular to the first direction. Shown at 17 are stock guides which hinge upward to a position perpendicular with the tailgate module surface which are used to locate materials to be cut with the saw 14. Alternatively, the stock guides 17 may extend upwardly from the surface 21, parallel to the longitudinal axis of the vehicle, in order to support longer pieces of stock during cutting. In addition, stock hangers or straps are shown at 18 which can hold construction materials which are ready to be cut. A local power outlet is shown at 19, which the saw or other power tool could be plugged into, which frees the work surface of extension cords and the like.

The tailgate module 10 may be molded of either thermoset or thermoplastic materials by any of a variety of manufacturing processes including injection molding, compression molding, blow molding, thermoforming, rotational molding, transfer molding and the like. Engineering thermoplastic are preferred for this module as they possess the properties of wear resistance, color stability, toughness and dimensional stability. Typical engineering thermoplastic may include but are not limited to polyesters, polystyrene, high impact polystyrene, styrene-butadiene copolymers, impact modified styrene-butadiene copolymer, poly-a-methyl styrene, styrene acrylonitrile copolymers, acrylonitrile-butadiene-styrene, acrylonitrile butadiene copolymers, polyisobutylene, polyvinyl chloride, polyvinylidene chloride, polyvinyl acetals, polyacrylonitrile, polyacrylates, polymethacrylatess, polybutadiene, ethylene-vinyl acetate, polyamides, polyimides, polyoxymethylene, polysulfones, polyphenylene sulfide, polyvinyl esters, melamines, vinyl esters, epoxies, polycarbonates, polyurethanes, styrene-maleic anhydride, polyether sulfones, polyacetals, phenolics, polyester carbonate, polyethers, polyethylene terephthalate, polybutylene terephthalate, polyarylates, polylene sulfides, polyether ketones, polyethylene, high density polyethylene, polypropylene, thermoplastic elastomers (TPE), thermoplastic olefins (TPO) thermoplastic rubber (TPR) and copolymers, grafts, blends, alloys and mixtures thereof

The molded tailgate module 10 may be in the form of a liner 11, which may be applied to the inside surface of a tailgate either to replace the metal inner surface or applied directly over the metal inner surface. Attachment may be by any of conventional methods including adhesive, welding and mechanical attachment means. Preferably the top edge of the liner is designed with a wrap-over feature to allow the liner to also protect the top edge of the tailgate (see FIG. 1).

Alternatively, the tailgate module 10 may be entirely of plastic molded as single unitary construction or of multiple components (inner, outer, hinge, handle) assembled together and finished to coordinate with the remainder of the bed of the vehicle.

The top surface 21 of the module may also be textured to assist in ease of placing and holding construction materials while work is being performed on them.

It may also be desirable to emboss or mold in place various logos and identifying marks that would identify the manufacturer of the tools being used (Craftsman, Hilti, Makita, etc.).

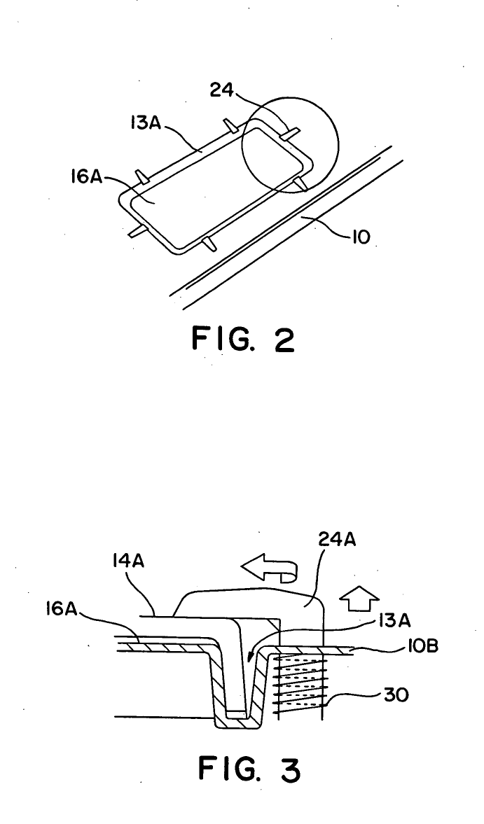

Turning now to FIG. 2, a more detailed view of the extending slot 13A and support surface 16A in the molded tailgate module 10A are shown. The bottom surface of power tool 14 may rest on the support surface 16A. Alternatively, the power tool may be supported by the marginal edges of the power tool base. Rotable spring-loaded clamps 24 are shown in a plurality of locations surrounding the slot in an extended or outward facing position. Once a tool, such as a saw is located in the extending slot 13A and secured against travel in the x and y directions, the spring loaded clamps 24 can be pulled up and rotated 180 degrees to positively lock the power tool safely into a working position. The clamps 24 restrict movement of the power tool 14 in a direction perpendicular to the surface 17.

FIG. 3 details the operation of the rotable spring loaded clamps 24A further, by displaying a sectional view of the encircled area indicated in FIG. 2. The clamp 24A acts against a spring 30 contained in the tailgate module assembly 10B to provide a downward force to hold the base of a power tool 14A securely against the tailgate module.

Other clamping methods known to those skilled in the art, such as DeStaco clamps can also be used.

This invention is not limited to use with pickup trucks but may also be used in a variety of vehicles such as SUV's, station wagons, ATV's, industrial utility vehicles, golf carts, and the like.

Thus, it can be seen that the invention provides a new and improved molded tailgate module which allows for use as a field working surface for craftsmen in the construction industries, by providing a surface comprising grooves or recesses that allow power tools to be mounted, supported and secured and features for locating and holding materials of construction.

The description and drawings illustratively set forth the presently preferred embodiments. The description and drawings are intended to describe these embodiments and not to limit the scope of the invention. Those skilled in the art will appreciate that still other modifications and variations of the present invention are possible in light of the above teaching while remaining within the scope of the following claims. Therefore, within the scope of the claims, one may practice the invention otherwise that as the description and drawings specifically shown and described.

1. A tailgate module for a vehicle comprising:
a top work surface (21) comprising one or a plurality of slots (13) configured to locate a base of a tool (14) in a first direction and a second direction, the second direction being substantially perpendicular to the first, said one or plurality of slots cooperating with a downwardly extending protrusion on the base of said tool; and
a clamp (24) for restricting movement of the base in a direction perpendicular to said first and said second direction.

2. The tailgate module of claim 1, wherein the clamp is spring loaded.

3. The tailgate module of claim 1, wherein the module comprises plastic.

4. The tailgate module of claim 1, wherein the tool is a power tool.

5. The tailgate module of claim 4, wherein the power tool is a saw.

6. The tailgate module of claim 1, further comprising a stock guide.

7. The tailgate module of claim 1, wherein the tailgate module comprises the inner surface of a conventional metal tailgate assembly and is securely attached thereto.

8. The tailgate module of claim 1, wherein the module is formed by a process selected from the group consisting of blow molding, thermoforming, injection molding, compression molding, reaction injection molding, and rotational molding.

9. The tailgate module of claim 1, wherein the module comprises a tailgate molded of unitary construction.

10. The tailgate module of claim 9, wherein the module is formed by a process selected from the group consisting of blow molding, thermoforming, injection molding, compression molding, reaction injection molding, and rotational molding.

11. The tailgate module of claim 1, wherein the module comprises multiple plastic components assembled together.

12. A tailgate module for a vehicle comprising:
a top work surface comprising a depression configured to cooperate with a downwardly extending protrusion on a base of a tool, the depression configured to positively locate the base of a tool in a first direction and a second direction, the second direction being perpendicular to the first; and
a clamp for restricting movement of the base in a direction perpendicular to the said first and said second direction.

13. The tailgate module of claim 12, wherein the clamp is spring loaded.

14. The tailgate module of claim 12, wherein the module comprises plastic.

15. The tailgate module of claim 12, wherein the tool is a power tool.

16. The tailgate module of claim 15, wherein the power tool is a saw.

17. The tailgate module of claim 12, further comprising a stock guide.

18. The tailgate module of claim 12, wherein the tailgate module comprises the inner surface of a conventional metal tailgate assembly and is securely attached thereto.

19. The tailgate module of claim 12, wherein the module is formed by a process selected from the group consisting of blow molding, thermoforming, injection molding, compression molding, reaction injection molding, and rotational molding.

20. The tailgate module of claim 12, wherein the module comprises a tailgate molded of unitary construction.

21. The tailgate module of claim 19, wherein the module is formed by a process selected form the group consisting of blow molding, thermoforming, injection molding, compression molding, reaction injection molding and rotational molding.

22. The tailgate module of claim 12, wherein the module comprises multiple plastic components assembled together.

23. A tailgate module for a vehicle comprising:
a top work surface comprising a protrusion configured to cooperate with a depression on a base of a tool, the protrusion configured to positively locate the base of a tool in a first direction and a second direction, the second direction being perpendicular to the first; and
a clamp for restricting movement of the base in a direction perpendicular to the said first and said second direction.
